(19) United States
(12) Patent Application Publication
(10) Pub. No.: US 2025/0191850 A1
(43) Pub. Date: Jun. 12, 2025

(54) CAPACITOR

(71) Applicant: Panasonic Intellectual Property Management Co., Ltd., Osaka (JP)

(72) Inventors: Yoshitaka NAKAMURA, OSAKA FU (JP); Kotaro ONO, OSAKA FU (JP); Hitoshi ISHIMOTO, HYOGO KEN (JP)

(21) Appl. No.: 18/846,474

(22) PCT Filed: Feb. 24, 2023
(86) PCT No.: PCT/JP2023/006866

§ 371 Date: Sep. 12, 2024

(30) Foreign Application Priority Data
Mar. 14, 2022 (JP) 2022-039610

(51) Int. Cl. H01G 9/032; H01G 9/028; H01G 9/15

(52) U.S. Cl. CPC H01G 9/032; H01G 9/028; H01G 9/15

(57) ABSTRACT

A capacitor disclosed includes an anode body having a dielectric layer formed on a surface of the anode body, a cathode extraction layer, and an n-type semiconductor layer that is disposed between the dielectric layer and the cathode extraction layer and is in contact with the cathode extraction layer. The work function of an n-type semiconductor that constitutes the n-type semiconductor layer is larger than or equal to the work function of an inorganic conductive material that constitutes the cathode extraction layer.

### TECHNICAL FIELD

The present disclosure relates to a capacitor.

### BACKGROUND ART

Various capacitors have been conventionally proposed. PTL 1 (Japanese Laid-Open Patent Publication No. 2017-103412) discloses “a solid electrolytic capacitor comprising: an anode body; a dielectric layer disposed on a surface of the anode body; and a solid electrolyte layer disposed on a surface of the dielectric layer and constituted using zinc oxide having a conductivity of 1 (S/cm) or more”.

PTL 2 (Japanese Laid-Open Patent Publication No. 2020-35890) discloses “a solid electrolytic capacitor comprising: an anode body made of a valve metal; a dielectric layer formed on a surface of the anode body; a semiconductor layer formed on the dielectric layer; and a cathode layer formed on the semiconductor layer, in which the semiconductor layer is constituted by using an inorganic p-type semiconductor”.

PTL 3 (International Publication WO 2015/059913) discloses “an electrolytic capacitor comprising: an anode body having a dielectric layer formed on a surface of the anode body; a cathode body having a nickel layer formed on a surface of the cathode body; and a solid electrolyte formed between the anode body and the cathode body and containing a conductive polymer, wherein the nickel layer contains nickel crystal particles having a length of 50 nm or more in a direction perpendicular to a thickness direction of the nickel layer in a cross section obtained by cutting the nickel layer in the thickness direction”. Further, PTL 3 discloses an electrolytic capacitor in which the work function of the nickel layer is larger than the work function of the conductive polymer.

### CITATION LIST

### Patent Literature

PTL 1: Japanese Laid-Open Patent Publication No. 2017-103412
PTL 2: Japanese Laid-Open Patent Publication No. 2020-35890
PTL 3: International Publication WO 2015/059913

### SUMMARY OF INVENTION

### Technical Problem

In recent years, there has been demand for capacitors having low ESR. In such a situation, one object of the present disclosure is to provide a capacitor having a low equivalent series resistance (ESR).

### Solution to Problem

One aspect of the present disclosure relates to a capacitor. The capacitor includes an anode body having a dielectric layer formed on a surface of the anode body, a cathode extraction layer, and an n-type semiconductor layer that is disposed between the dielectric layer and the cathode extraction layer and is in contact with the cathode extraction layer, wherein a work function of an n-type semiconductor that constitutes the n-type semiconductor layer is larger than or equal to a work function of an inorganic conductive material that constitutes the cathode extraction layer.

Another aspect of the present disclosure relates to another capacitor. The other capacitor includes an anode body having a dielectric layer formed on a surface of the anode body, a cathode extraction layer, and a p-type semiconductor layer that is disposed between the dielectric layer and the cathode extraction layer and is in contact with the cathode extraction layer, wherein a work function of a p-type semiconductor that constitutes the p-type semiconductor layer is smaller than or equal to a work function of an inorganic conductive material that constitutes the cathode extraction layer.

Another aspect of the present disclosure relates to another capacitor. The other capacitor includes an anode body having a dielectric layer formed on a surface of the anode body, a cathode extraction layer, and a conductive polymer layer that is disposed between the dielectric layer and the cathode extraction layer and is in contact with the cathode extraction layer, wherein the conductive polymer layer is constituted of a conductive polymer exhibiting a p-type semiconductor property, and a work function of the conductive polymer is smaller than or equal to the work function of an inorganic conductive material that constitutes the cathode extraction layer.

### Advantageous Effects of Invention

According to the present disclosure, it is possible to obtain a capacitor capable of reducing the ESR.

While novel features of the present invention are set forth particularly in the appended claims, the present invention, both as to organization and content, will be better understood and appreciated, along with other objects and features thereof, from the following detailed description taken in conjunction with the drawings.

### BRIEF DESCRIPTION OF DRAWINGS

FIG. 1 A diagram schematically showing an example of a band structure of constituent members of a capacitor.

FIG. 2 A diagram schematically showing an example of a contact state in which an n-type semiconductor layer and a cathode extraction layer are in contact with each other in a first capacitor.

FIG. 3 A diagram schematically showing an example of a contact state in which a p-type semiconductor layer and a cathode extraction layer are in contact with each other in a second capacitor.

FIG. 4 A diagram schematically showing another example of a band structure of constituent members of a capacitor.

FIG. 5 A diagram schematically showing an example of a contact state in which a conductive polymer layer and the cathode extraction layer are in contact with each other in the second capacitor.

FIG. 6 A cross-sectional view schematically showing a structure of an example of a capacitor according to this embodiment.

FIG. 7 A cross-sectional view schematically showing a structure of another example of the capacitor according to this embodiment.

FIG. 8 A cross-sectional view schematically showing an evaluation method used in Examples.

### DESCRIPTION OF EMBODIMENTS

Although an embodiment according to the present disclosure will be described below using an example, the present disclosure is not limited to the example described below. Although specific numerical values and materials may be mentioned as examples in the following description, other numerical values and other materials may be used as long as the invention according to the present disclosure can be implemented. The term “range of numerical value A to numerical value B” used in this specification includes the numerical value A and the numerical value B, and can be read as “range of numerical value A or more to numerical value B or less”. In the following description, when lower limits and upper limits of numerical values regarding specific physical properties, conditions, or the like are given as examples, any of the above-mentioned lower limits and any of the above-mentioned upper limits can be combined, as long as the lower limit is not greater than or equal to the upper limit.

Three types of capacitors (first to third capacitors) will be described below as a capacitor according to the present disclosure. Hereinafter, the first to third capacitors may be collectively referred to as a “capacitor (C)”.

### (First Capacitor)

A first capacitor includes an anode body having a dielectric layer formed on its surface, a cathode extraction layer, and an n-type semiconductor layer that is disposed between the dielectric layer and the cathode extraction layer and is in contact with the cathode extraction layer. The work function of an n-type semiconductor that constitutes the n-type semiconductor layer is larger than or equal to the work function of an inorganic conductive material that constitutes the cathode extraction layer.

The cathode extraction layer is disposed facing the dielectric layer present on the anode body. Typically, the n-type semiconductor layer is in contact with the dielectric layer on the anode body. That is, the first capacitor has a stacked structure of the anode body/the dielectric layer/the n-type semiconductor layer/the cathode extraction layer. Because the stacked structure does not include a polymer such as a conductive polymer layer, a capacitor having high heat resistance can be obtained. However, another layer may be disposed between the dielectric layer and the n-type semiconductor layer. For example, another n-type semiconductor layer may be disposed therebetween, or a conductive polymer layer or the like may be disposed therebetween.

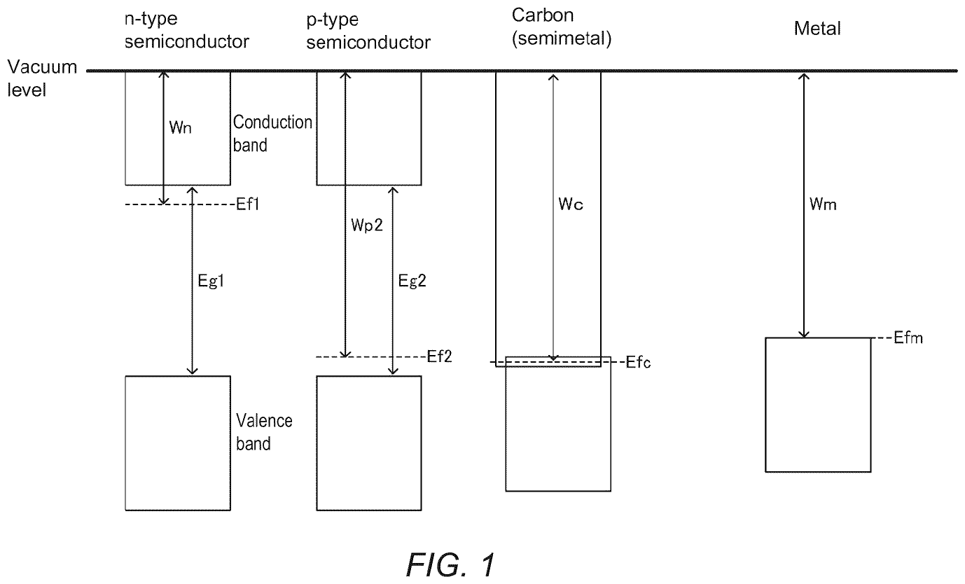

FIG. 1 schematically shows a band diagram of an n-type semiconductor, a p-type semiconductor, a semimetal (conductive carbon), and a metal. FIG. 1 shows a band gap Eg1, the Fermi level Ef1, and a work function Wn of the n-type semiconductor. Also, FIG. 1 shows a band gap Eg2, the Fermi level Ef2, and a work function Wp2 of the p-type semiconductor. Also, FIG. 1 shows the Fermi level Efc and a work function Wc of a conductive carbon, which is a semimetal. Also, FIG. 1 shows the Fermi level Efm and a work function Wm of the metal. The work function of each material is determined by a difference between the vacuum level and the Fermi level.

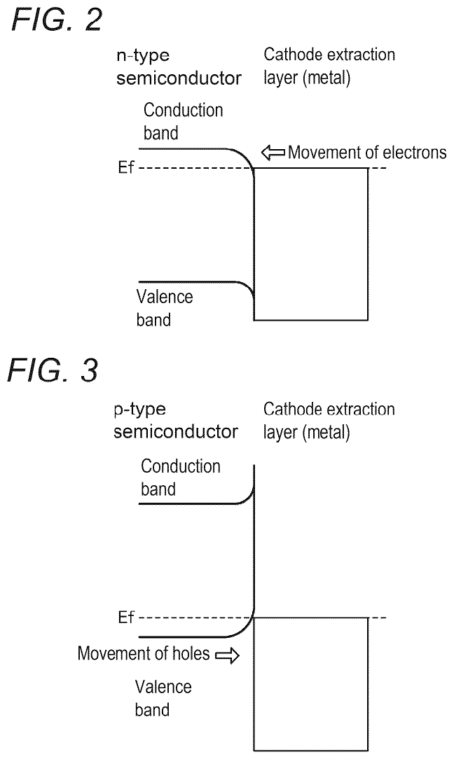

A case is considered where the work function Wn of the n-type semiconductor that constitutes the n-type semiconductor layer is larger than or equal to a work function Wi1 of an inorganic conductive material that constitutes the cathode extraction layer. For example, a case is considered where a metal having a work function of Wm (note that Wm≤Wn holds true) is used as an inorganic conductive material that constitutes the cathode extraction layer. In this case, when the n-type semiconductor layer and the cathode extraction layer are bonded together, the band structure thereof is in the state shown in FIG. 2. As shown in FIG. 2, when Wm≤Wn (Wi1≤Wn) holds true, there is no barrier to the flow of electrons, and the n-type semiconductor layer and the cathode extraction layer are in an ohmic contact. Thus, it is possible to reduce the ESR of a capacitor having this configuration. Note that an ohmic contact may include a contact that can be regarded as a substantially ohmic contact in this specification.

There is no particular limitation on the thickness of the n-type semiconductor layer, and the thickness of the n-type semiconductor layer may be 1 nm or more, 10 nm or more, 100 nm or more, or 1 μm or more, and 100 μm or less, 10 μm or less, or 1 μm or less. The thickness thereof may be in a range of 1 nm to 100 μm (e.g., in a range of 10 nm to 10 μm).

There is no particular limitation on the n-type semiconductor as long as Wi1≤Wn is satisfied. The n-type semiconductor may be a metal oxide, and for example, any one of ZnO, indium tin oxide (ITO), In₂O₃, and Ga₂O₃ may be used. These may be doped with a dopant, have an oxygen deficiency, or have an excessive oxygen.

The work function Wn of the n-type semiconductor may be 4.65 eV or more. The work function Wn varies depending on the material of the n-type semiconductor. Further, the Wn can be changed by a production method in some cases. The Wn may be 4.93 eV or more. There is no particular limitation on the upper limit of the Wn, and the Wn may be 6.00 eV or less.

Examples of combinations of an n-type semiconductor that constitutes the n-type semiconductor layer and an inorganic conductive material that constitutes the cathode extraction layer in the first capacitor will be described later.

### (Second Capacitor)

A second capacitor includes an anode body having a dielectric layer formed on its surface, a cathode extraction layer, and a p-type semiconductor layer that is disposed between the dielectric layer and the cathode extraction layer and is in contact with the cathode extraction layer. The work function of a p-type semiconductor that constitutes the p-type semiconductor layer is smaller than or equal to the work function of the inorganic conductive material that constitutes the cathode extraction layer.

The cathode extraction layer is disposed facing the dielectric layer present on the anode body. Typically, the p-type semiconductor layer is in contact with the dielectric layer on the anode body. That is, the second capacitor has a stacked structure of the anode body/the dielectric layer/the p-type semiconductor layer/the cathode extraction layer. Because the stacked structure does not include a polymer such as a conductive polymer layer, a capacitor having high heat resistance can be obtained. However, another layer may be disposed between the dielectric layer and the p-type semiconductor layer. For example, another p-type semiconductor layer may be disposed therebetween, or a conductive polymer layer or the like may be disposed therebetween.

A case is considered where the work function Wp2 of the p-type semiconductor that constitutes the p-type semiconductor layer is smaller than or equal to the work function Wi2 of the inorganic conductive material that constitutes the cathode extraction layer. For example, a case is considered where a metal having a work function of Wm (note that Wp2≤Wm holds true) is used as an inorganic conductive material that constitutes the cathode extraction layer. In this case, when the p-type semiconductor and the cathode extraction layer are bonded together, the band structure thereof is in the state shown in FIG. 3. As shown in FIG. 3, when Wp2≤Wm (Wp2≤Wi2) holds true, there is no barrier to the flow of holes, and the p-type semiconductor and the cathode extraction layer are in an ohmic contact. Thus, it is possible to reduce the ESR of a capacitor having this configuration.

There is no particular limitation on the thickness of the p-type semiconductor layer, and the thickness of the p-type semiconductor layer may be 1 nm or more, 10 nm or more, 100 nm or more, or 1 μm or more, and 100 μm or less, 10 μm or less, or 1 μm or less. The thickness thereof may be in a range of 1 nm to 100 μm (e.g., in a range of 10 nm to 10 μm).

There is no particular limitation on the p-type semiconductor as long as Wp2≤Wi2 is satisfied. The p-type semiconductor may be a metal oxide, and for example, any one of NiO, MnO₂, and CuInO₂ may be used. These may be doped with a dopant, have an oxygen deficiency, or have an excessive oxygen.

The work function Wp2 of the p-type semiconductor may be 4.90 eV or less. The work function Wp2 varies depending on the material of the p-type semiconductor. Further, the Wp2 can be changed by a production method in some cases. The Wp2 may be 4.80 eV or less or 4.40 eV or less. There is no particular limitation on the lower limit of the Wp2, and the Wp2 may be 2.10 eV or more.

Examples of combinations of an p-type semiconductor that constitutes the p-type semiconductor layer and an inorganic conductive material that constitutes the cathode extraction layer in the second capacitor will be described later.

The first and second capacitors may contain a conductive polymer. However, as described above, the first and second capacitors can be constructed without using a conductive polymer. In such a case, a capacitor with high heat resistance can be obtained.

### (Third Capacitor)

A third capacitor includes an anode body having a dielectric layer formed on its surface, a cathode extraction layer, and a conductive polymer layer that is disposed between the dielectric layer and the cathode extraction layer and is in contact with the cathode extraction layer. The conductive polymer layer is constituted of a conductive polymer exhibiting a p-type semiconductor property. The conductive polymer may be referred to as a “p-type conductive polymer” hereinafter. The work function of the conductive polymer is smaller than or equal to the work function of the inorganic conductive material that constitutes the cathode extraction layer. From one point of view, the conductive polymer layer can be regarded as a p-type semiconductor layer.

The cathode extraction layer is disposed facing the dielectric layer present on the anode body. Typically, the conductive polymer layer is in contact with the dielectric layer on the anode body. That is, the first capacitor has a stacked structure of the anode body/the dielectric layer/the conductive polymer layer/the cathode extraction layer. However, another layer may be disposed between the dielectric layer and the conductive polymer layer. For example, another p-type conductive polymer layer may be disposed therebetween.

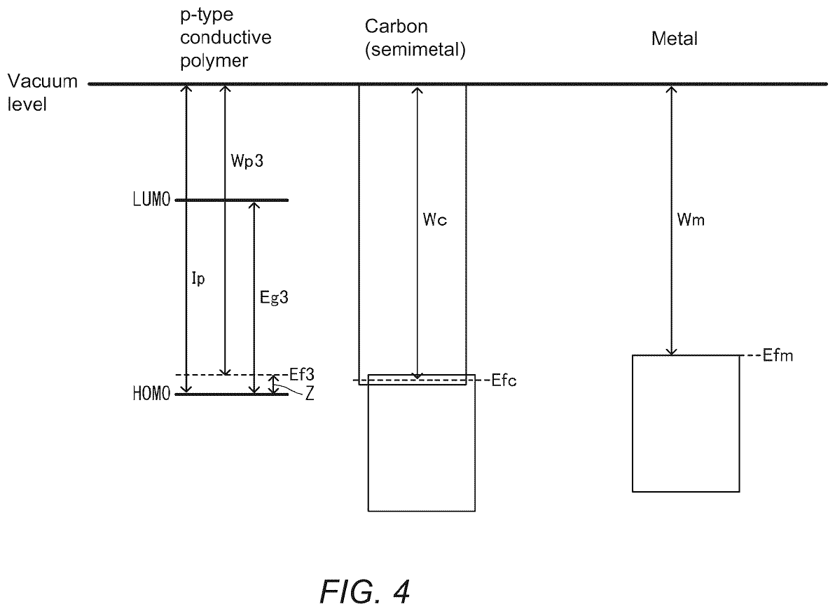

FIG. 4 schematically shows a band diagram of a p-type conductive polymer, a semimetal (conductive carbon), and a metal. FIG. 4 shows a work function Wp3, a band gap Eg3, the Fermi level Ef3, and ionization potential Ip of the p-type conductive polymer. Similarly to FIG. 1, FIG. 4 also shows a band structure of a semimetal and a metal. Z in FIG. 4 is a difference between the Fermi level Ef3 and the highest occupied molecular orbital (HOMO) energy level (HOMO level).

The ionization potential Ip is determined by the difference between the vacuum level and the highest occupied molecular orbital (HOMO) energy level (HOMO level). The band gap Eg3 is determined by the difference between the lowest unoccupied molecular orbital (LUMO) energy level (LUMO level) and the HOMO level. The work function Wp3 is determined using Wp3=(Ip-Z). The ionization potential Ip of the conductive polymer and the work function of the semiconductor layer can be measured using the method described in the Examples.

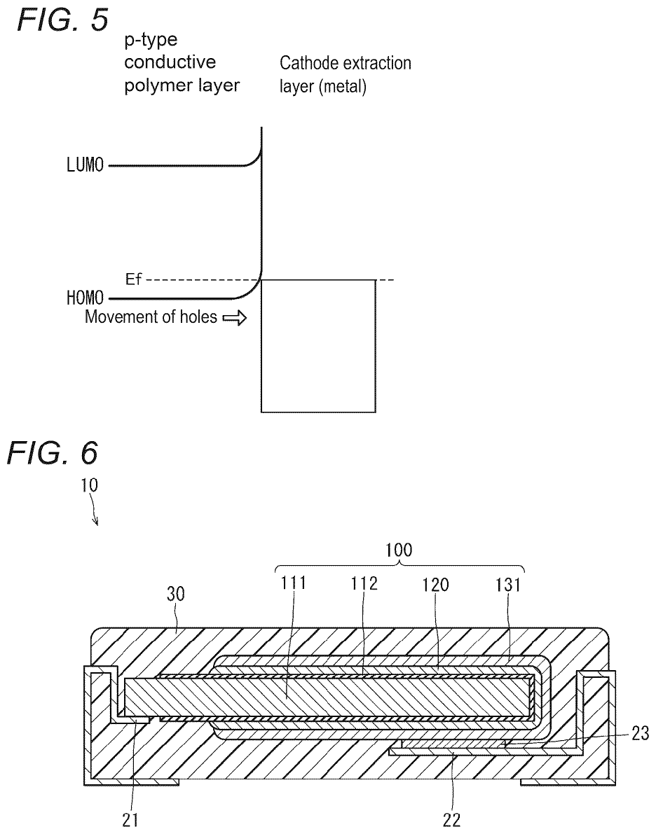

A case is considered where the work function Wp3 of the conductive polymer that constitutes the conductive polymer layer is smaller than or equal to the work function Wi3 of the inorganic conductive material that constitutes the cathode extraction layer. For example, a case is considered where a metal having a work function of Wm (note that Wp3_Wm holds true) is used as an inorganic conductive material that constitutes the cathode extraction layer. In this case, when the conductive polymer layer and the cathode extraction layer are bonded together, the band structure thereof is in the state shown in FIG. 5. As shown in FIG. 5, when Wp3≤Wm (Wp3≤Wi3) holds true, there is no barrier to the flow of holes, and the conductive polymer layer and the cathode extraction layer are in an ohmic contact. Thus, it is possible to reduce the ESR of a capacitor having this configuration.

Considering the ionization potential Ip and the above Z, when (Ip-Z)≤Wi3 holds true, an ohmic contact is formed. That is, when (Ip-Wi3)≤Z holds true, an ohmic contact is formed. For example, when Z is 0.2 eV or more, an ohmic contact is formed if (Ip-0.2)≤Wi3 (i.e., (Ip-Wi3)≤0.2) is satisfied. Note that the Z value can be changed by the content rate of dopant or the like. The Z value can be reduced by increasing the content rate of dopant.

There is no particular limitation on the thickness of the p-type conductive polymer layer, and the thickness of the p-type conductive polymer layer may be 1 nm or more, 10 nm or more, 100 nm or more, or 1 μm or more, and 100 μm or less, 10 μm or less, or 1 μm or less. The thickness thereof may be in a range of 1 nm to 100 μm (e.g., in a range of 10 nm to 10 μm).

There is no particular limitation on the p-type conductive polymer as long as Wp3≤Wi3 is satisfied. Examples of the p-type conductive polymer include polypyrrole, polythiophene, polyaniline, and derivatives thereof. These polymers may be used alone or in a combination of two or more. Also, the conductive polymer may be a copolymer of two or more types of monomers. Note that a derivative of a conductive polymer means a polymer having the conductive polymer as a basic structure. For example, examples of polythiophene derivatives include poly(3,4-ethylenedioxythiophene) (PEDOT). The p-type conductive polymer may be a polypyrrole-based polymer. Examples of polypyrrole-based polymers (polypyrroles) include polypyrrole and derivatives thereof. The p-type conductive polymer may be at least one polymer selected from the group consisting of polypyrrole and polypyrrole derivatives. Examples of polypyrrole derivatives include poly(alkylpyrroles). The alkyl group is bonded to a nitrogen atom or a carbon atom that is included in a 5-membered ring. The alkyl group may have 1 to 3 carbon atoms.

The conductive polymer layer may contain a dopant. The dopant is selected depending on the conductive polymer. There is no particular limitation on the dopant, and a known dopant may be used. Examples of the dopants include dopants such as sulfuric acid and sulfonic acid salts. For example, examples of the dopants include benzenesulfonic acid, alkylbenzenesulfonic acid, naphthalenesulfonic acid, alkylnaphthalenesulfonic acid, polystyrenesulfonic acid (PSS), and salts thereof. The conductive polymer layer may contain PEDOT doped with PSS. The conductive polymer that constitutes a conductive polymer layer may contain PEDOT doped with PSS or be PEDOT doped with PSS.

The p-type conductive polymer may be a conductive polymer obtained by adding, as a dopant, a sulfonic acid salt to a polypyrrole-based polymer. Examples of polypyrrole-based polymers include polypyrrole and derivatives thereof. Examples of sulfonic acid salts include sodium naphthalene sulfonate-based compounds. Examples of sodium naphthalene sulfonate-based compounds include sodium naphthalene sulfonate and derivatives thereof. The sodium naphthalene sulfonate-based compounds may be at least one selected from the group consisting of sodium naphthalene sulfonate and derivatives thereof. Examples of sodium naphthalene sulfonate-based compounds include sodium propylnaphthalene sulfonate and sodium octafluoropentyl naphthalene polysulfonate. The p-type conductive polymer may be a p-type conductive polymer obtained by doping polypyrrole with a sulfonic acid salt (e.g., a sodium naphthalene sulfonate-based compound).

The ionization potential of the p-type conductive polymer may be 5.11 eV or less.

The p-type conductive polymer layer may be constituted of one type of conductive polymer or may be constituted of a plurality of types of conductive polymers. When the p-type conductive polymer layer is constituted of a plurality of conductive polymers, out of these conductive polymers, a conductive polymer serving as a main component (a component with the highest content rate) satisfies the above relationship. All of the plurality of conductive polymers preferably satisfy the above relationship.

In the first to third capacitors, an inorganic conductive material that constitutes the cathode extraction layer is selected depending on the work function or the ionization potential of materials that constitute adjacent layers (the above-mentioned n-type semiconductor layer, p-type semiconductor layer, and conductive polymer layer). The inorganic conductive material may be conductive carbon. Alternatively, the inorganic conductive material may be silver, copper, gold, platinum, or an alloy containing at least one of them. An inorganic conductive material that constitutes the cathode extraction layer may contain or may be at least one selected from the group consisting of conductive carbon, silver, copper, gold, and platinum. Examples of conductive carbon include graphite, carbon black, graphene flakes, and carbon nanotubes.

The inorganic conductive material that constitutes the cathode extraction layer may be constituted of one type of material or may contain a plurality of types of materials. When the inorganic conductive material contains a plurality of types of conductive materials, out of these conductive materials, a conductive material serving as a main component (a component with the highest content rate) satisfies the above relationship. All of the plurality of conductive materials preferably satisfy the above relationship.

### (Method for Producing Capacitor (C))

There is no particular limitation on a method for producing a capacitor (C), and constituent elements other than the p-type semiconductor layer of the first capacitor, the n-type semiconductor layer of the second capacitor, and the p-type conductive polymer layer of the second capacitor may be formed using known methods.

There is no limitation on methods for forming the p-type semiconductor layer of the first capacitor and the n-type semiconductor layer of the second capacitor, and these layers may be formed using a known method. Examples of the method for forming these layers include a gas phase method for forming a layer in a gas phase or a liquid phase method for forming a layer in a liquid phase. Examples of the gas phase method include a vapor deposition method, a sputtering method, an atomic layer deposition method (ALD method), and a chemical vapor deposition method (CVD method). Examples of the liquid phase method include a sol-gel method, a chemical bath deposition method, a liquid phase deposition method, a hydrothermal method, a flux method, a coating method, an electroplating, and electroless plating. It is preferable to select these methods in consideration of the material and the determined work function of the material of a semiconductor layer.

There is no particular limitation on the method for forming a conductive polymer layer of the third capacitor, and the conductive polymer layer may be formed using a known method. For example, a conductive polymer layer may be formed using a dispersion liquid containing the p-type conductive polymer. The dispersion liquid contains a dopant as needed. Alternatively, a conductive polymer layer may be formed through electrolytic polymerization.

Examples of the configuration and constituent members of the capacitor (C) will be described below. Known constituent members may be applied to constituent members other than those of distinctive parts of the present disclosure.

### (Anode Body)

An anode body can be formed using a valve metal, an alloy containing a valve metal, a compound containing a valve metal, or the like. These materials may be used alone or in a combination of two or more. Aluminum, tantalum, niobium, or titanium is preferably used as a valve metal. A foil (e.g., a metal foil such as an aluminum foil) made of the above-mentioned material may be used as an anode body.

An anode body having a porous portion in its surface can be obtained by, for example, roughening the surface of a metal foil containing a valve metal. Roughening may be performed through electrolytic etching or the like.

Alternatively, the anode body may be formed by sintering particles made of the above-mentioned material. For example, the anode body may be a sintered body of tantalum. When the anode body is a sintered body, a porous portion is present in a surface of the anode body. When the anode body is a sintered body, the capacitor (C) may include an anode wire whose portion is embedded in the sintered body.

### (Dielectric Layer)

A dielectric layer is an insulating layer that functions as a dielectric. The dielectric layer may be formed by anodizing a valve metal of the surface of the anode body (e.g., a metal foil). It is sufficient that the dielectric layer is formed to cover at least a portion of the anode body. The dielectric layer is usually formed on the surface of the anode body. When a porous portion is present in the surface of the anode body, the dielectric layer is formed on the surface of the porous portion of the anode body.

A typical dielectric layer includes an oxide of a valve metal. For example, a typical dielectric layer when tantalum is used as a valve metal contains Ta₂O₅, and a typical dielectric layer when aluminum is used as a valve metal contains Al₂O₃. Note that the dielectric layer is not limited to this, and may be any dielectric layer that functions as a dielectric.

### (Cathode Extraction Layer)

The cathode extraction layer is a conductive layer. As described above, the cathode extraction layer contains an inorganic conductive material. The cathode extraction layer may be formed using particles of an inorganic conductive material (conductive carbon particles, metal particles, or the like). Specifically, the cathode extraction layer may be formed using a carbon paste containing conductive carbon particles or a metal paste containing metal particles. Alternatively, the cathode extraction layer may include a layer made of only conductive carbon or a layer made of only a metal (a vapor deposition layer or a metal foil). Examples of the metal paste include a paste containing particles of the above-described metal.

Note that at least another conductive layer may be formed on the cathode extraction layer. In such a case, it is conceivable that the cathode extraction layer includes a first cathode extraction layer disposed on a surface on the anode body side, and a second cathode extraction layer (another conductive layer) formed on the first cathode extraction layer. In such a case, the first cathode extraction layer is in contact with the n-type semiconductor layer of the first capacitor, the p-type semiconductor layer of the second capacitor, or the conductive polymer layer of the third capacitor. Therefore, a material whose work function satisfies the above condition is selected as an inorganic conductive material that constitutes the first cathode extraction layer. There is no particular limitation on the material of another conductive layer (the second cathode extraction layer), and any of the materials mentioned as examples of the material of the cathode extraction layer (the first cathode extraction layer) may also be used.

The cathode extraction layer may contain a component other than the inorganic conductive material. Examples of such a component include a resin that functions as a binding agent. However, the conductivity of the cathode extraction layer is provided by an inorganic conductive material. Usually, the content rate of the inorganic conductive material in the cathode extraction layer is 50% by mass or more (e.g., in a range of 70% by mass to 100% by mass).

### (Lead Member and Exterior Body)

There is no particular limitation on a lead member and an exterior body, and a known lead member and a known exterior body may be used.

### (Structure of Capacitor (C))

The capacitor (C) may include only one capacitor element. Alternatively, the capacitor (C) may include a plurality of capacitor elements. For example, the capacitor (C) may include a plurality of capacitor elements connected in parallel to each other. The plurality of capacitor elements (C) are usually connected in parallel in a stacked state, and are covered with the exterior body.

Examples of the embodiment according to the present disclosure will be specifically described below with reference to the drawings. The above-described constituent elements can be applied to exemplary constituent elements described below. Also, the examples described below can be modified based on the above description. Further, items described below may be applied to the above embodiment. Also, in the embodiment described below, constituent elements that are not essential to the capacitor according to the present disclosure may be omitted. Note that the figures below are illustrative and may differ from the actual configuration.

### Embodiment 1

In Embodiment 1, an example of the first capacitor will be described. FIG. 6 is a cross-sectional view schematically showing an example of the first capacitor. A capacitor 10 shown in FIG. 6 includes a capacitor element 100, an anode lead 21, a cathode lead 22, a metal paste layer 23, and an exterior body 30. The metal paste layer 23 is the above-described conductive layer (L).

The capacitor element 100 includes an anode body 111, a dielectric layer 112, an n-type semiconductor layer 120, and a cathode extraction layer 131. The dielectric layer 112 is formed to cover at least a portion of the surface of the anode body 111. The n-type semiconductor layer 120 is formed to cover at least a portion of the dielectric layer 112. The cathode extraction layer 131 is formed to cover at least a portion of the n-type semiconductor layer 120. The work function of an n-type semiconductor that constitutes the n-type semiconductor layer 120 is larger than or equal to the work function of an inorganic conductive material that constitutes the cathode extraction layer 131.

The anode lead 21 is connected to the anode body 111. The cathode lead 22 is connected to the cathode extraction layer 131 via the metal paste layer 23. The metal paste layer 23 is formed of a metal paste (silver paste). The exterior body 30 is formed to cover a portion of the anode lead 21, a portion of the cathode lead 22, and the capacitor element 100. A portion of the anode lead 21 and a portion of the cathode lead 22 are exposed from the exterior body 30, and function as terminals.

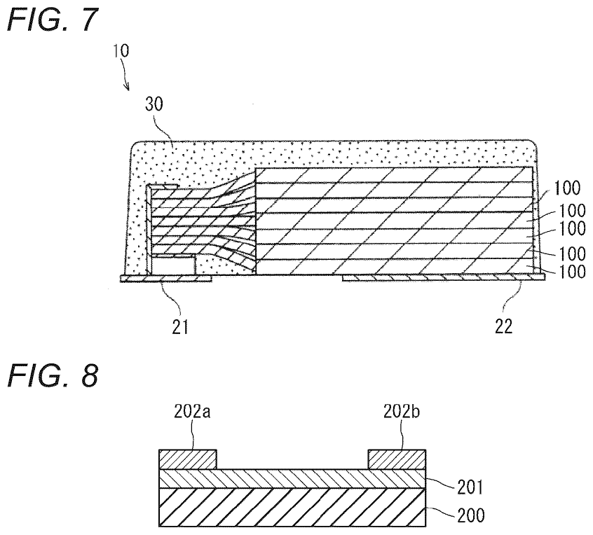

FIG. 6 shows a case where the capacitor 10 includes one capacitor element 100. However, the capacitor 10 may include a plurality of capacitor elements 100. FIG. 7 shows a schematic cross-sectional view of an example of the capacitor 10 including the plurality of capacitor elements 100. Note that some members are not shown in FIG. 7 to make FIG. 7 easy to read.

The capacitor 10 shown in FIG. 7 includes a plurality of capacitor elements 100 stacked on each other. The plurality of capacitor elements 100 are connected in parallel.

Note that, in the case of the second capacitor, the n-type semiconductor layer 120 need only be changed to a p-type semiconductor layer. In the case of the third capacitor, the n-type semiconductor layer 120 need only be changed to a conductive polymer layer constituted of a p-type conductive polymer. In these cases, the p-type semiconductor layer, the p-type conductive polymer, and the inorganic conductive material that constitutes the cathode extraction layer 131 are selected to satisfy the above-described relationship.

### EXAMPLES

Hereinafter, the capacitor (C) will be further specifically described using Examples. In the following Examples, layers made of various materials were formed using various methods. Then, the work functions or ionization potential of the formed layers were measured using the following method.

In the measurement of the work function of a semiconductor (semiconductor layer), first, a semiconductor thin film was formed on a glass substrate. Then, the work function of the formed semiconductor thin film was measured using an ultraviolet photoelectron spectrometer (UPS) (AC-2 manufactured by Riken Keiki Co., Ltd.).

In the measurement of the ionization potential of the conductive polymer (conductive polymer layer), first, a conductive polymer film was formed through electrolytic polymerization. Then, the ionization potential of the formed conductive polymer film was measured using the ultraviolet photoelectron spectrometer (UPS) (AC-2 manufactured by Riken Keiki Co., Ltd.).

### Example 1

In Example 1, the contact between the n-type semiconductor and the cathode extraction layer in the first capacitor was examined. Regarding combinations of the n-type semiconductor and the materials of various cathode extraction layers, Table 1 shows the work function Wn of the n-type semiconductor, the work function Wi1 of a material of a cathode extraction layer, and the types of contacts formed by combinations thereof.

TABLE 1

| | | | Material of | Work | | |
|---|---|---|---|---|---|---|
| | n-type | Work | Cathode | Function | Wn − | |
| | Semi- | Function | Extraction | Wi1 | Wi1 | |
| Number | conductor | Wn (eV) | Layer | (eV) | (eV) | Contact |
| A1 | Al—ZnO | 4.64 | Carbon | 4.91 | −0.27 | Schottky |
| A2 | (sputtering | | Silver | 4.65 | −0.01 | Schottky |
| A3 | method) | | Copper | 5.24 | −0.60 | Schottky |
| A4 | | | Gold | 5.10 | −0.46 | Schottky |
| A5 | | | Platinum | 5.65 | −1.01 | Schottky |
| A6 | Al—ZnO | 5.24 | Carbon | 4.91 | 0.33 | Ohmic |
| A7 | (liquid | | Silver | 4.65 | 0.59 | Ohmic |
| A8 | phase | | Copper | 5.24 | 0.00 | Ohmic |
| A9 | growth | | Gold | 5.10 | 0.14 | Ohmic |
| A10 | method) | | Platinum | 5.65 | −0.41 | Schottky |
| A11 | ZnO | 5.38 | Carbon | 4.91 | 0.47 | Ohmic |
| A12 | (liquid | | Silver | 4.65 | 0.73 | Ohmic |
| A13 | phase | | Copper | 5.24 | 0.14 | Ohmic |
| A14 | growth | | Gold | 5.10 | 0.28 | Ohmic |
| A15 | method) | | Platinum | 5.65 | −0.27 | Schottky |
| A16 | ITO | 4.93 | Carbon | 4.91 | 0.02 | Ohmic |
| A17 | (sputtering | | Silver | 4.65 | 0.28 | Ohmic |
| A18 | method) | | Copper | 5.24 | −0.31 | Schottky |
| A19 | In:Sn = 9:1 | | Gold | 5.10 | −0.17 | Schottky |
| A20 | | | Platinum | 5.65 | −0.72 | Schottky |
| A21 | In₂O₃ | 5.00 | Carbon | 4.91 | 0.09 | Ohmic |
| A22 | | | Silver | 4.65 | 0.35 | Ohmic |
| A23 | | | Copper | 5.24 | −0.24 | Schottky |
| A24 | | | Gold | 5.10 | −0.10 | Schottky |
| A25 | | | Platinum | 5.65 | −0.65 | Schottky |
| A26 | Ga₂O₃ | 6.00 | Carbon | 4.91 | 1.09 | Ohmic |
| A27 | | | Silver | 4.65 | 1.35 | Ohmic |
| A28 | | | Copper | 5.24 | 0.76 | Ohmic |
| A29 | | | Gold | 5.10 | 0.90 | Ohmic |
| A30 | | | Platinum | 5.65 | 0.35 | Ohmic |

In Table 1, the work functions of In₂O₃, Ga₂O₃, gold, and platinum are not measured values but are values obtained from the literature. The other work functions are values measured using the above-described method. The atomic ratio of In to Sn in ITO was In: Sn=9:1. Graphite (particle size was 0.5 to 1.0 μm) was used as carbon.

Al—ZnO represents ZnO doped with Al. Al—ZnO (liquid phase growth method) in Table 1 was formed using a liquid phase growth method (liquid phase method). Specifically, first, an aqueous solution in which zinc nitrate, aluminum nitrate, and hexamethylenetetramine were dissolved was prepared. Then, a glass substrate was immersed in the aqueous solution at 85° C. until an Al—ZnO layer having a predetermined thickness was formed. After the immersion, the formed Al—ZnO layer was dried at 120° C. for 10 minutes. ZnO (liquid phase growth method) in Table 1 was formed using a liquid phase growth method (liquid phase method). Specifically, first, an aqueous solution in which zinc nitrate and hexamethylenetetramine were dissolved was prepared. Then, a glass substrate was immersed in the aqueous solution at 85° C. until a ZnO layer having a predetermined thickness was formed. After the immersion, the formed ZnO layer was dried at 120° C. for 10 minutes. Al—ZnO (sputtering method) and ITO (sputtering method) in Table 1 were formed using a sputtering method.

In Table 1, when 0≤Wn-Wi1 (i.e., Wi1≤Wn) holds true, the n-type semiconductor layer and the cathode extraction layer were in an ohmic contact. In the first capacitor, the n-type semiconductor and the material of the cathode extraction layer were selected such that the contact therebetween was an ohmic contact.

As shown in Table 1, when the Al—ZnO layer was formed through sputtering method, a Schottky contact was formed when a conductive material (conductive material that is usually used) shown in Table 1 was used for the cathode extraction layer. Such a fact was not known in the past. The Al—ZnO layer and the ZnO layer are preferably formed using a liquid phase method, because the relationship Wi1≤Wn is easily satisfied.

The Al—ZnO (sputtering method), Al—ZnO (liquid phase growth method), and ZnO (liquid phase growth method) layers were analyzed using an X-ray diffraction method (XRD method). As a result, a lattice constant C of ZnO in the c-axis direction was 5.1762 angstroms for Al—ZnO (sputtering method), 5.1308 angstroms for Al—ZnO (liquid phase growth method), and 5.1302 angstroms for ZnO (liquid phase growth method). The lattice constant C of ZnO formed using the liquid phase growth method was small, and the lattice constant C of ZnO formed through sputtering method was large.

Further, stacked structures corresponding to A1 to A3 and A16 to A18 shown in Table 1 were formed and resistance values were measured. Specifically, as shown in FIG. 8, a first layer 201 made of an n-type semiconductor was formed on a glass substrate 200, and two second layers 202a and 202b were formed on the first layer 201 at a distance from each other. The second layers 202a and 202b were formed using the material of a cathode extraction layer. Then, a resistance value between the second layer 202a and the second layer 202b was measured. The measurement results are shown in Table 2.

TABLE 2

| | | | | Resistance |
|---|---|---|---|---|
| | n-type | Material of Cathode | Wn-Wi1 | Value |
| Number | Semiconductor | Extraction Layer | (eV) | (Ω) |
| A1 | Al—ZnO | Carbon | −0.27 | 55 |
| A2 | (sputtering | Silver | −0.01 | 55 |
| A3 | method) | Copper | −0.60 | 116 |
| A16 | ITO | Carbon | 0.02 | 14 |
| A17 | (sputtering | Silver | 0.28 | 16 |
| A18 | method) | Copper | −0.31 | 20 |

As shown in Table 2, combinations of A1 to A3 and A18, which were in Schottky contacts, had high resistance values. On the other hand, combinations of A16 and A17, which were in ohmic contacts, had low resistance values.

### Example 2

In Example 2, the contact between the p-type semiconductor and the cathode extraction layer in the second capacitor was examined. Regarding combinations of the p-type semiconductor and the materials of various cathode extraction layers, Table 3 shows the work function Wp2 of the p-type semiconductor, the work function Wi2 of a material of a cathode extraction layer, and the types of contacts formed by combinations.

TABLE 3

| | | Work | Material of | Work | | |
|---|---|---|---|---|---|---|
| | p-type | Function | Cathode | Function | Wp2 − | |
| | Semi- | Wp2 | Extraction | Wi2 | Wi2 | |
| Number | conductor | (eV) | Layer | (eV) | (eV) | Contact |
| B1 | NiO | 2.10 | Carbon | 4.91 | −2.81 | Ohmic |
| B2 | | | Silver | 4.65 | −2.55 | Ohmic |
| B3 | | | Copper | 5.24 | −3.14 | Ohmic |
| B4 | | | Gold | 5.10 | −3.00 | Ohmic |
| B5 | | | Platinum | 5.65 | −3.55 | Ohmic |
| B6 | MnO₂ | 4.40 | Carbon | 4.91 | −0.51 | Ohmic |
| B7 | | | Silver | 4.65 | −0.25 | Ohmic |
| B8 | | | Copper | 5.24 | −0.84 | Ohmic |
| B9 | | | Gold | 5.10 | −0.70 | Ohmic |
| B10 | | | Platinum | 5.65 | −1.25 | Ohmic |
| B11 | CuInO₂ | 4.80 | Carbon | 4.91 | −0.11 | Ohmic |
| B12 | | | Silver | 4.65 | 0.15 | Schottky |
| B13 | | | Copper | 5.24 | −0.44 | Ohmic |
| B14 | | | Gold | 5.10 | −0.30 | Ohmic |
| B15 | | | Platinum | 5.65 | −0.85 | Ohmic |

The work functions of NiO, MnO₂, and CulnO₂, gold, and platinum are not measured values but are values obtained from the literature. The other work functions are values measured using the above-described method.

In Table 3, when Wp2-Wi2≤0 (i.e., Wp2≤Wi2) holds true, the p-type semiconductor layer and the cathode extraction layer were in an ohmic contact. In the second capacitor, the p-type semiconductor and the material of the cathode extraction layer were selected such that the contact therebetween was an ohmic contact.

### Example 3

In Example 3, the contact between the p-type conductive polymer layer and the cathode extraction layer in the third capacitor was examined. Regarding combinations of the conductive polymer layer formed using a p-type conductive polymer and the materials of various cathode extraction layers, Table 4 shows the ionization potential Ip of the conductive polymer, the work function Wp3 of the conductive polymer, the work function Wi3 of the material of the cathode extraction layer, and the types of contacts formed by the combinations. Note that the value of the work function Wp3 was a value obtained on the presumption that the above Z value was 0.2 eV.

TABLE 4

| | | | Work | Material of | Work | | |
|---|---|---|---|---|---|---|---|
| | | | Function | Cathode | Function | Wp3 − | |
| | Conductive | Ip | Wp3 | Extraction | Wi3 | Wi3 | |
| Number | Polymer | (eV) | (eV) | Layer | (eV) | (eV) | Contact |
| C1 | Polymer 1 | 4.95 | 4.75 | Carbon | 4.91 | −0.16 | Ohmic |
| C2 | | | | Silver | 4.65 | 0.10 | Schottky |
| C3 | | | | Copper | 5.24 | −0.49 | Ohmic |
| C4 | | | | Gold | 5.10 | −0.35 | Ohmic |
| C5 | | | | Platinum | 5.65 | −0.90 | Ohmic |
| C6 | Polymer 2 | 5.11 | 4.91 | Carbon | 4.91 | 0.00 | Ohmic |
| C7 | | | | Silver | 4.65 | 0.26 | Schottky |
| C8 | | | | Copper | 5.24 | −0.33 | Ohmic |
| C9 | | | | Gold | 5.10 | −0.19 | Ohmic |
| C10 | | | | Platinum | 5.65 | −0.74 | Ohmic |

A polymer 1 in Table 4 was polypyrrole doped with sodium propylnaphthalene sulfonate. A polymer 2 in Table 4 was polypyrrole doped with sodium octafluoropentyl naphthalene polysulfonate.

Actual measurement of the contact states of combinations of C1, C6, and C7 revealed that C1 and C6 were in ohmic contacts and C7 was in a Schottky contact.

In Table 4, when Wp3-Wi3≤0 (i.e., Wp3≤Wi3) holds true, the conductive polymer layer and the cathode extraction layer were in an ohmic contact. In the third capacitor, the conductive polymer and the material of the cathode extraction layer were selected such that the contact therebetween was an ohmic contact.

When it is presumed that the Z value is 0.2 eV, an ohmic contact is formed if Wp3=(Ip-0.2)≤Wi3 is satisfied. In other words, when (Ip-0.2)≤Wi3 (i.e., (Ip-Wi3)≤0.2) is satisfied, an ohmic contact is formed if 0.2≤Z is satisfied.

### INDUSTRIAL APPLICABILITY

The present disclosure can be used for a capacitor.

Although the present invention has been described in terms of the presently preferred embodiments, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10: capacitor, 100: capacitor element, 111: anode body, 112: dielectric layer, 120: n-type semiconductor layer, 131: cathode extraction layer

1. A capacitor comprising:
an anode body having a dielectric layer formed on a surface of the anode body;
a cathode extraction layer; and
an n-type semiconductor layer that is disposed between the dielectric layer and the cathode extraction layer and is in contact with the cathode extraction layer,
wherein a work function of an n-type semiconductor that constitutes the n-type semiconductor layer is larger than or equal to a work function of an inorganic conductive material that constitutes the cathode extraction layer.

2. The capacitor according to claim 1,
wherein the n-type semiconductor is any one of ZnO, indium tin oxide, In₂O₃, and Ga₂O₃.

3. The capacitor according to claim 1,
wherein the work function of the n-type semiconductor is 4.65 eV or more.

4. A capacitor comprising:
an anode body having a dielectric layer formed on a surface of the anode body;
a cathode extraction layer; and
a p-type semiconductor layer that is disposed between the dielectric layer and the cathode extraction layer and is in contact with the cathode extraction layer,
wherein a work function of a p-type semiconductor that constitutes the p-type semiconductor layer is smaller than or equal to a work function of an inorganic conductive material that constitutes the cathode extraction layer.

5. The capacitor according to claim 4,
wherein the p-type semiconductor is any one of NiO, MnO₂, and CulnO₂.

6. The capacitor according to claim 4,
wherein the work function of the p-type semiconductor is 4.90 eV or less.

7. A capacitor comprising:
an anode body having a dielectric layer formed on a surface of the anode body;
a cathode extraction layer; and
a conductive polymer layer that is disposed between the dielectric layer and the cathode extraction layer and is in contact with the cathode extraction layer,
wherein the conductive polymer layer is constituted of a conductive polymer exhibiting a p-type semiconductor property, and
a work function of the conductive polymer is smaller than or equal to a work function of an inorganic conductive material that constitutes the cathode extraction layer.

8. The capacitor according to claim 7,
wherein a work function Wi3 (eV) of the inorganic conductive material and ionization potential Ip (eV) of the conductive polymer satisfy (Ip-Wi3)≤0.2.

9. The capacitor according to claim 7,
wherein the conductive polymer is a conductive polymer obtained by adding, as a dopant, a sulfonic acid salt to a polypyrrole-based polymer.

10. The capacitor according to claim 7,
wherein ionization potential of the conductive polymer is 5.11 eV or less.

11. The capacitor according to claim 7,
wherein the inorganic conductive material is at least one selected from the group consisting of conductive carbon, silver, copper, gold, and platinum.
